(19) United States
(12) Patent Application Publication
(10) Pub. No.: US 2004/0216540 A1
(43) Pub. Date: Nov. 4, 2004

(54) Torus crank mechanism

(76) Inventor: Jin-Hee Choi, Seoul (KR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/484,842

(22) PCT Filed: Jul. 23, 2002
(86) PCT No.: PCT/KR02/01386

(30) Foreign Application Priority Data
Jul. 25, 2001 (KR) 2001-0044704
May 14, 2002 (KR) 2002-0026443

(51) Int. Cl. F16H 21/44

(52) U.S. Cl. 74/23

(57) ABSTRACT

Disclosed is a torus crank mechanism including a housing assembly (100) providing sealed chambers (145 to 148), a core (200) centrally arranged in the housing assembly while having a vertical shaft (215 or 216) protruded from one or each of upper and lower surfaces of the core, and horizontal shafts (211 to 214), a rotor (300) adapted to rotate in a reciprocating fashion around the core while having rotating vanes (311 to 314) arranged in respective chambers, and guide slots (315 to 318), bevel gears (410 to 440) rotatably supported by respective horizontal shafts while having respective eccentric sliders (411, 421, 431, and 441) rotatably and slidably received in the guide slots, and an output gear (500 or 600) rotatably supported by the vertical shaft. A multiple torus crank mechanism is configured by coaxially connecting torus crank mechanisms each having the above described configuration.

### TECHNICAL FIELD

The present invention relates to a torus crank mechanism for converting an input reciprocating rotating motion into a one-directional rotating motion, or converting an input one-directional rotating motion into a reciprocating rotating motion.

### BACKGROUND ART

Crank mechanisms are well known as devices for converting an input reciprocating linear motion into a one-directional rotating motion. For example, there is a crank mechanism having an arrangement in which a connecting rod is connected to an input part, that is, a piston, and an output part, that is, a crank shaft, is connected to the connecting rod. Such a crank mechanism is mainly used in internal combustion engines. In such a case, reciprocating linear motions of the piston are converted into a one-directional rotating motion of the crank shaft. Meanwhile, when the crank shaft is adapted as an input part, its one-directional rotating motion is converted into reciprocating linear motions of the piston. Crank mechanisms having such an arrangement may be mainly used in compressors or pumps.

However, the above mentioned general crank mechanisms have an increased volume due to the stroke length of the piston, the length of the connecting rod, and the space required for rotation of an eccentric part of the crank shaft. For this reason, the crank mechanisms have very poor volume efficiency. Furthermore, there is a disadvantage in that the engines, actuators, compressors, or pumps using the crank mechanisms are heavy. Such a disadvantage is remarkably exhibited where the crank mechanisms are applied to high horse power engines or actuators, or high capacity compressors or pumps. In particular, where such a crank mechanism is applied to an engine for ships, the resultant engine may have a greatly increased size while having an increased weight. For this reason, it is difficult to manufacture the engine. High manufacturing costs are also required.

Furthermore, the above mentioned general crank mechanisms involve generation of increased vibrations and noise because input and output shafts, which are input and output parts respectively, are installed in different directions at different places, and due to frictional resistance occurring at a plurality of moving elements. In addition, these crank mechanisms are uneconomical in terms of case of manufacture and operating efficiency.

Where an engine using such a general crank mechanism is turned over, the lubricant present in the crank chamber flows reversely toward the cylinder head, thereby causing the engine to be stopped. As a result, the combustion chamber, cylinder and piston may be mechanically damaged.

In order to eliminate the disadvantages of the general crank mechanisms, diverse rotary engines have been proposed. Although these proposals have been mainly made to provide an engine capable of reducing the inevitable disadvantages associated with the general crank mechanisms while being economical in terms of fuel efficiency, and lightweight, they have little or no usefulness in association with commercial purposes, so that most of them are not commercially available. The commercially available rotary engine is what is called a Wankel type engine. Generally, Wankel type engines include a toroidal cylinder formed in a cylinder housing surrounding a drive shaft assembly, a rotor means coupled to the toroidal cylinder, and rotatably supported around the drive shaft assembly while having rotating vanes movable relative to each other, thereby defining a chamber for expansion and compression in the toroidal cylinder, and intake and exhaust ports extending through a housing assembly while serving to introduce fluid into the chamber and to exhaust the fluid from the chamber. In some rotary engines, an external mechanism is used in order to selectively move the rotor means in the interior of the cylinder. Also, there are rotary engines in which an inclined rotating plate and a cam are used in order to mechanically couple necessary drive elements.

Such a Wankel type engine can more or less eliminate the problems involved with the above described general crank mechanisms. However, this engine has an inefficient operating configuration. It is also impossible to maintain an optimum output distribution. For this reason, the Wankel type engine has been used in limited applications. For example, it is difficult to use the Wankel type engine as a substitute for typical reciprocating piston engines such as engines for vehicles or industrial lightweight engines which can be manufactured by mass production. Furthermore, although the Wankel type engine provides a sufficient output performance at high speed, its output performance is considerably degraded at low speed, as compared to engines using the general crank mechanism.

Most conventional Wankel type engines have a power transmission means utilizing the operating principle of a crank shaft, even though this crank shaft is more or less different from the crank shaft of the general crank mechanism. For this reason, an increase in engine volume is inevitably involved. In other words, it is impossible to completely eliminate the problem of a decrease in volume efficiency involved with the general crank mechanism. In addition, the conventional Wankel type engines require a complicated and sophisticated manufacturing and assembling process, so that it is difficult to inexpensively manufacture those engines by mass production.

In order to solve such problems, the inventor has proposed a coaxial type reciprocating engine. This coaxial type reciprocating engine is disclosed in Korean Patent No. 292988, to which U.S. Pat. No. 6,186,095 corresponds.

This coaxial type reciprocating engine includes a housing assembly including a first stator having first and second circular plates, and a plurality of fixed blocks attached to the second circular plate, a second stator having third and fourth circular plates while being arranged to face the first stator, and a circular housing surrounding the first and second stators, a plate arranged outside the first stator. The coaxial type reciprocating engine also includes a rotor mounted in the housing assembly, and provided with a plurality of rotating vanes defining chambers for expansion and compression, a gear box fixedly mounted in the rotor, an output shaft rotatably mounted to the gear box, and a power transmission unit for transmitting a rotating force from the rotor to the output shaft via a drive shaft. The power transmission unit includes guide rails provided at the inner circumferential surface of the rotor while facing each other, and provided with guide channels, a slider provided with guide slots to move vertically along the guide rails, and a ball housing formed at one end thereof with a ball seat for receiving a ball included in the slider, and at the other end thereof with an extension having a coupling portion to be rotatably coupled with a coupling hole formed at a flat member. In this coaxial type reciprocating engine, the reciprocating rotating motion of the rotor mounted in the housing assembly is converted into a one-directional rotating motion of the output shaft via the power transmission unit.

Although the above mentioned coaxial reciprocating engine has a theoretical configuration capable of sufficiently obtaining a desired power, it is impossible to obtain a large torque at high speed because the number of elements constituting the power transmission unit is large, and a large number of links are used, thereby resulting in a weak structure. Furthermore, the distance between the rotor and the output shaft is large, so that a high moment is generated. Also, there are problems of an unstable structure and increased vibrations because the power transmission unit and links have different rotating central axes. Moreover, there are structural drawbacks of an increased volume and an unstable gear box mounting because a large number of links and a gear box should be used. In addition, the rotor may be deformed or damaged by inertial forces because there is no structure capable of withstanding pressure generated in an inward direction (the radially inward direction toward the central axis of the housing) during a combustion procedure.

### DISCLOSURE OF THE INVENTION

The present invention has been made in view of the above mentioned problems, and an object of the invention is to provide a torus crank mechanist including input and output parts respectively having central axes aligned with each other, in order to convert a reciprocating rotating motion of the input part into an one-directional rotating motion of the output part, or to convert an one-directional rotating motion of the input part into a reciprocating rotating motion of the output part, thereby being capable of achieving an improvement in volume efficiency.

Another object of the invention is to provide a torus crank mechanism having a reduced sliding contact area between mechanical elements in order to reduce suffering of mechanical damage caused by inertial forces, vibrations, and noise, while having a simple structure having a superior mechanical strength and durability in order to provide an efficient power transmission means while being easily manufactured and assembled, thereby being capable of providing inexpensive engines, actuators, compressors or pumps by mass production.

Another object of the invention is to provide a torus crank mechanism capable of minimizing generation of vibrations.

Another object of the invention is to provide a torus crank mechanism in which opposite power shafts adapted to output power to opposite sides or to input power at opposite sides are configured to rotate in the same direction without using any separate direction change means or any complex link mechanism for cranking operations.

Another object of the invention is to provide a multiple torus crank mechanism which can be easily configured by coaxially connecting a plurality of housing assemblies, while having power shafts configured in the same rotating direction, thereby being capable of achieving an improvement in power output efficiency and power input efficiency.

In order to accomplish these objects, the present invention provides a torus crank mechanism comprising: a housing assembly providing at least one sealed chamber; a core centrally arranged in the housing assembly, the core having a vertical shaft protruded from one or each of upper and lower surfaces of the core, and at least one horizontal shaft radially outwardly protruded from an outer circumferential surface of the core; a rotor arranged in the housing assembly to rotate in a reciprocating fashion around the core, the rotor having at least one rotating vane at an outer circumferential surface thereof, and at least one guide slot at an inner circumferential surface thereof, the rotating vane being arranged in the chamber; a bevel gear rotatably supported by the horizontal shaft of the core, the bevel gear having an eccentric slider rotatably and slidably received in the guide slot; and an output gear rotatably supported by the vertical shaft protruded from one or each of the upper and lower core surfaces.

In accordance with the present invention, the housing assembly may comprises a housing body having an outer profile including an upper surface formed with a circular recess, a lower surface formed with a through hole, and side surfaces, first and second covers respectively coupled to the upper and lower surfaces of the housing body, and at least two fixed blocks received in the circular recess to partition the circular recess, thereby defining at least one chamber. The core may be integral with the housing body by a plurality of support members extending from the lower surface of the housing body to the upper surface of the housing body.

Guide members made of a material having a strength and hardness higher than those of the rotor may be mounted to respective side walls of the guide slot in order to prevent the rotor from being abraded at both side walls of the guide slot by the eccentric slider rotatably received in the guide slot.

Preferably, the eccentric slider of the bevel gear is inclined by a desired angle so that it is directed to a center of the housing assembly at any position of the guide slot. The bevel gear may have a guide portion formed at a surface of the bevel gear where the eccentric slider is formed, and a balance weight portion formed at a surface of the bevel gear opposite to the bevel gear surface where the eccentric slider is formed. The guide portion has the same radius of curvature as the rotor, and the balance weight portion serves to maintain a desired balance during the rotation of the bevel gear. In the case in which the bevel gear has the guide portion, the rotor is preferably provided with guide members respectively mounted to respective side walls of the guide slot. Each of the guide members may have an arc-shaped support portion formed at a front surface of the guide member, and curved to have the same radius of curvature as the guide portion of the bevel gear. A guide roller may be mounted to the eccentric slider of the bevel gear, in order to allow the eccentric slider to move smoothly in the guide slot.

In accordance with a preferred embodiment of the present invention, the housing assembly has at least two chambers. The core is provided with at least two rotating vanes each received in an associated one of the chambers. The rotor is arranged in the housing assembly to rotate in a reciprocating fashion around the core. At least two guide slots are formed at an inner circumferential surface of the core. The guide slots are arranged in pairs so that the guide slots of each guide slot pair face each other. At least two bevel gears are rotatably supported by respective horizontal shafts of the core.

In accordance with another preferred embodiment of the present invention, the housing assembly has at least four chambers. The core is provided with at least four rotating vanes each received in an associated one of the chambers. The rotor is arranged in the housing assembly to rotate in a reciprocating fashion around the core. At least four guide slots are formed at an inner circumferential surface of the core. The guide slots are arranged in pairs so that the guide slots of each guide slot pair face each other. At least four bevel gears are rotatably supported by respective horizontal shafts of the core.

Where the rotor is used as an input part, the torus crank mechanism of the present invention can configure various industrial engines or actuators. On the other hand, where the output gear is used as an input part, the torus crank mechanism can configure compressors or pumps. In either case, the central axes of the input and output parts are aligned with each other in the torus crank mechanism of the present invention. In accordance with the torus crank mechanism having the above described configuration according to the present invention, it is not necessary to use mechanical elements occupying a large operating space, for example, crank shafts, as compared to general crank mechanisms. Accordingly, it is possible to obtain an improvement in volume and weight efficiencies while providing a simple arrangement. In this regard, it is possible to provide an engine, actuator, compressor, or pump greatly reduced in size and weight as compared to conventional ones, while maintaining the same horse power output.

Since the torus crank mechanism of the present invention has a simple and efficient operating configuration, it is possible to manufacture inexpensive engines, actuators, compressors and pumps by mass production.

Where a plurality of bevel gears are used in the torus crank mechanism having the above described configuration, the eccentric sliders of the bevel gears preferably have eccentric phases having a phase difference of 180° from one another in the rotating direction of the bevel gears. In this case, deviations in a center of gravity caused by the eccentric phases of the eccentric sliders provided at respective bevel gears are completely offset by the facing bevel gears of the bevel gear pairs. Accordingly, it is possible to reduce vibrations generated when the eccentric sliders are moved in the guide slots of the rotor.

The bevel gears are preferably engaged, in an alternating fashion, with the output gear arranged at the upper core surface and the output gear arranged at the lower core surface. In this case, the bevel gears engaged with the upper output gear and the bevel gears engaged with the lower output gear rotate in opposite directions, respectively, thereby causing the upper and lower output gears to rotate in the same direction. Accordingly, power shafts respectively connected to the upper and lower output gears can be rotated in the same direction.

Taking into consideration the fact that the upper and lower output gears can be rotated in the same direction, the upper and lower output gears and the core may have coaxial central through holes, respectively. In this case, a power shaft extends through the central through hole of the core so that opposite ends thereof is coupled with the central through holes of the upper and lower output gears, respectively. Accordingly, power can be outputted or inputted using the power shaft at opposite sides of the power shaft.

In accordance with the present invention, a multiple torus crank mechanism can be simply configured by coaxially connecting at least two torus crank mechanisms each having the above described configuration. That is, the torus crank mechanism of the present invention has a superior applicability to a high horse power engine or actuator, or a large capacity compressor or pump. In this case, it is preferred that among the output gears of the torus crank mechanisms, the output gears arranged adjacent to each other be integrally formed to have a single output gear structure.

### BRIEF DESCRIPTION OF THE DRAWINGS

The above objects, and other features and advantages of the present invention will become more apparent after a reading of the following detailed description when taken in conjunction with the drawings, in which:

FIG. 1 is an exploded perspective view illustrating a torus crank mechanism according to an embodiment of the present invention;

FIG. 2 is a perspective view illustrating an assembled inner configuration of the torus crank mechanism shown in FIG. 1;

FIG. 3 is a partially-broken perspective view corresponding to a part of FIG. 2;

FIG. 4 is a plan view illustrating a coupling relation between a housing assembly and a core included in the torus crank mechanism according to the embodiment of the present invention;

FIG. 5 is a cross-sectional view taken along the line V-V of FIG. 4;

FIG. 6 is a perspective view illustrating one example of a rotor included in the torus crank mechanism according to the embodiment of the present invention;

FIG. 7 is a plan view corresponding to FIG. 6;

FIG. 8 is a cross-sectional view taken along the line VIII-VIII of FIG. 7;

FIGS. 9 and 10 are a perspective view and a plan view respectively illustrating a bevel gear included in the torus crank mechanism according to the embodiment of the present invention;

FIG. 11 is a plan view illustrating an arrangement relation between the rotor and bevel gears included in the torus crank mechanism according to the embodiment of the present invention;

FIG. 12 is a view illustrating a co-operation between a guide slot provided at the rotor and an eccentric slider provided at the bevel gear in the torus crank mechanism according to the embodiment of the present invention;

FIG. 13 is a view illustrating an operation according to an inclination of the eccentric slider provided at each bevel gear in the torus crank mechanism according to the embodiment of the present invention;

FIG. 14 is a plan view illustrating another example of the bevel gear included in the torus crank mechanism according to the embodiment of the present invention;

FIG. 15 is a perspective view illustrating another example of the rotor included in the torus crank mechanism according to the embodiment of the present invention;

FIG. 16 is a perspective view illustrating one example of a guide member provided at the rotor shown in FIG. 15;

FIG. 17 is a partially-broken perspective view illustrating one example of an engagement relation between the bevel gears and output gears in the torus crank mechanism according to the embodiment of the present invention;

FIG. 18 is a partially-broken perspective view illustrating another example of the engagement relation;

FIGS. 19 and 20 are perspective views respectively illustrating an eccentric phase relation among eccentric sliders provided at respective bevel gears in the torus crank mechanism according to the embodiment of the present invention;

FIG. 21 is an exploded perspective view illustrating one example of a multiple torus crank mechanism, that is, a double torus crank mechanism, according to another embodiment of the present invention; and

FIGS. 22 to 24 are schematic views respectively illustrating power outputting/inputting relations in the double torus crank mechanism.

### BEST MODE FOR CARRYING OUT THE INVENTION

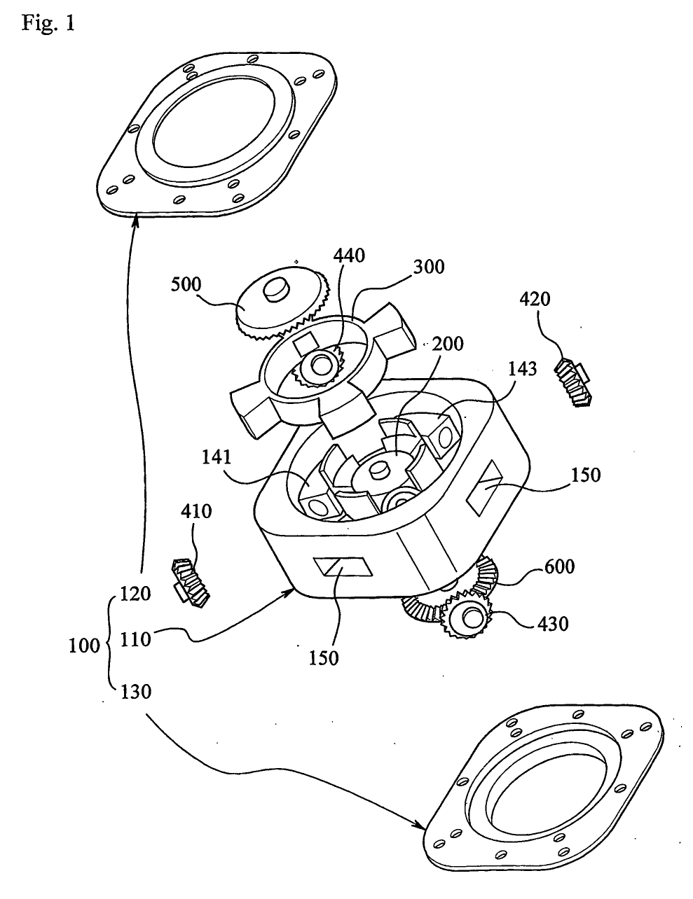

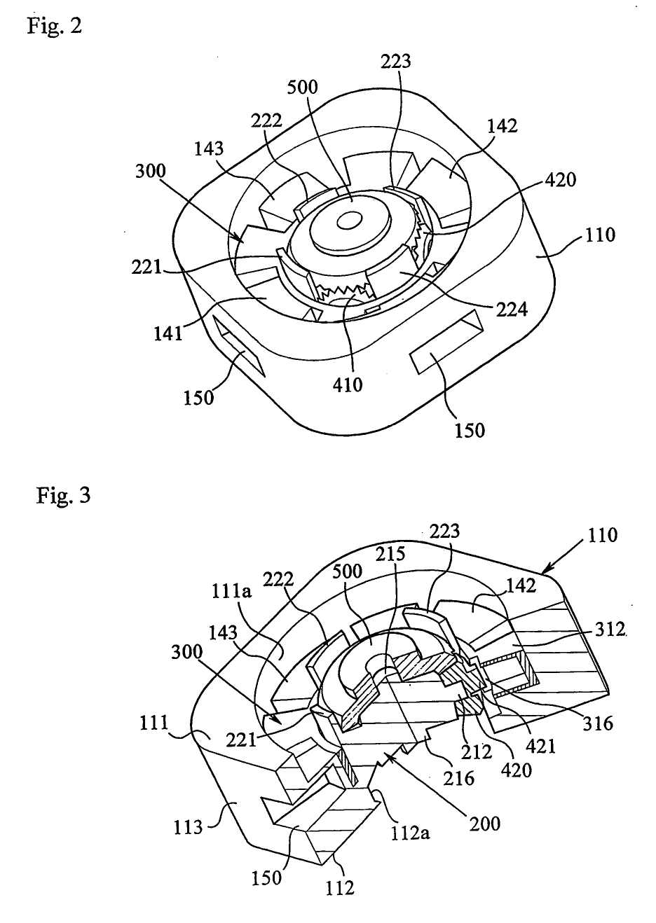

Referring to FIGS. 1 to 5, a torus crank mechanism according to the present invention is illustrated. In FIGS. 1 to 5, the reference numeral “100” denotes a housing assembly, “200” a core, “300” a rotor, “410”, “420”, “430”, and “440” respective bevel gears, and “500” and “600” respective output gears. For convenience of description, the following description will be given in conjunction with the case in which the four bevel gears 410 to 440 are applied to the torus crank mechanism according to the present invention.

The core 200 is centrally arranged in the housing assembly 100. The rotor 300 is arranged around the core 200 such that it is rotatable. The bevel gears 410 to 440 are rotatably mounted around the core 200. The output gears 500 and 600 are rotatably mounted at the top and bottom of the core 200, respectively.

The housing assembly 100 includes a housing body 110, a pair of covers, that is, a first cover 120 and a second cover 130, and a plurality of fixed blocks (in the illustrated case, four fixed blocks 141 to 144). The housing body 110 has a substantially box-shaped profile having an upper surface 111, a lower surface 112, and side surfaces 113. Although the housing body 110 has been illustrated as having a square or rectangular box shape, it is not limited thereto. For example, the housing body 110 may have other shapes, for example, a cylindrical shape, if desired. The housing body 110 is provided at its upper surface 111 with a circular recess 111a having a desired depth while being provided at its lower surface 112 with a through hole 112a. The first and second covers 120 and 130 are coupled to the upper and lower surfaces 111 and 112 of the housing body 110, respectively. The fixed blocks 141 to 144 are arranged in the circular recess 111a while being uniformly spaced apart from one another, in order to divide the circular recess 111a into a plurality of sub spaces. The fixed blocks 141 to 144 may be formed on the housing body 110 such that they are integral with the housing body 110. Alternatively, the fixed blocks 141 to 144 may be formed separately from the housing body 110, and subsequently coupled to the housing body 110. As the fixed blocks 141 to 144 partition the circular space 11a, at least one chamber (in the illustrated case, four chambers 145 to 148) is formed. The chambers 145 to 148 may have a rectangular cross-sectional shape, or a circular cross-sectional shape. That is, the chambers 145 to 148 may have diverse cross-sectional shapes in accordance with the shape of the fixed blocks 141 to 144.

In order to rotatably support at least one bevel gear (in the illustrated case, the four bevel gears 410 to 440) and at least one output gear (in the illustrated case, the two output gears 500 and 600), four horizontal shafts 211 to 214 and two vertical shafts 215 and 216 are formed at the core 200 such that they are integral with the core 200. The bevel gears 410 to 440 are rotatably supported by the horizontal shafts 211 to 214, respectively, whereas the output gears 500 and 600 are rotatably supported by the vertical shafts 215 and 216, respectively. Preferably, the core 200 is formed to be integral with the housing body 110 by a plurality of support members 221 to 224 extending from a lower surface 112 of the housing body 110 to an upper surface 111 of the housing body 110. Of course, the core 200 is not limited to such a structure. For example, the core 200 may be manufactured separately from the housing body 110, and subsequently assembled to the housing body 110 by the first and second covers 120 and 130. The support members 221 to 224 are preferably formed such that they are vertically symmetrical with respect to the core 200.

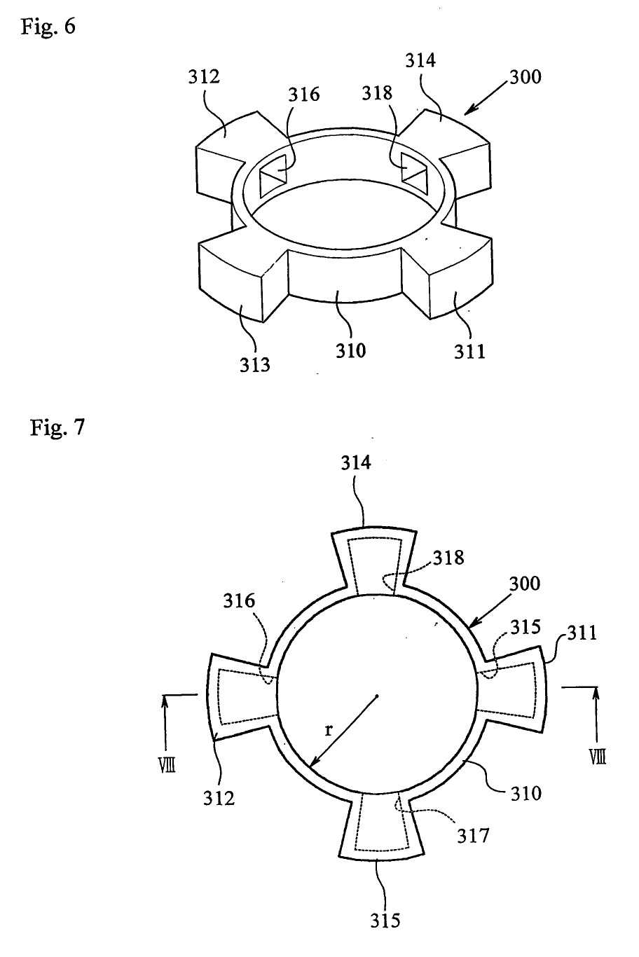

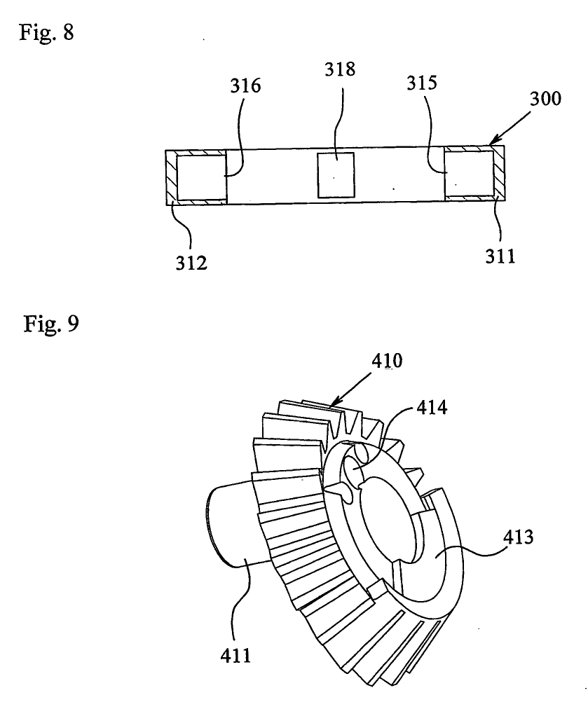

The rotor 300 is installed in the circular recess 111a defined in the housing body 110 of the housing assembly 100 such that it is bi-directionally rotatable. As shown in FIGS. 6 to 8, the rotor 300 includes an annular rotor body 310 with even distance therebetween, and a plurality of rotating vanes 311 to 314 formed around the annular rotor body 310, and received in respective chambers 145 to 148 defined in the circular recess 111a of the housing body 110 while having a width smaller than that of the associated chambers 145 to 148. The rotor body 310 is also provided at its inner circumferential surface (in particular, regions corresponding to respective rotating vanes 311 to 314) with a plurality of guide slots 315 to 318. The guide slots 315 to 318 are preferably arranged in pairs so that those in each guide slot pair face each other. Where the chambers 145 to 148 of the housing assembly 100 are matched with cylinder bores of a general engine or compressor, the rotating vanes 311 to 314 of the rotor 300 correspond to pistons of the general engine or compressor. Accordingly, it is advantageous for the rotor 300 to be lightweight In this regard, the rotor 300 is preferably made of aluminum alloys. It is also preferable for each of the vanes 311 to 314 to have a hollow structure. Where the guide slots 315 to 318 are formed at respective rotating vanes 311 to 314, they should not be extended throughout the rotating vanes 311 to 314.

As shown in FIGS. 9, 10, and 13, the bevel gears 410 to 440 rotatably supported by the horizontal shafts 211 to 214 of the core 200 are provided at their outer surfaces with eccentric sliders 411, 421, 431, and 441 adapted to be rotatably and slidably received in the guide slots 315 to 318, respectively. The eccentric sliders 411, 421, 431, and 441 are arranged while being eccentric from respective central axes of the associated bevel gears 410 to 440 by a desired angle. When the rotor 300 rotates in a reciprocating fashion, the bevel gears 410 to 440 are rotated only in one direction because the guide slots 315 to 318 and eccentric sliders 411, 421, 431, and 441 serve as a scotch yoke mechanism. Also, each of the bevel gears 410 to 440 may include a guide portion 412, a balance weight portion 413, and a plurality of hollow portions 414. The guide portion 412 is preferably formed by an arc surface formed at the surface of the associated bevel gear, on which the associated eccentric slider is formed, while having a radius of curvature, r₁, corresponding to the radius of curvature, r, of the inner surface of the rotor body 310. Accordingly, the guide portion 412 comes into sliding contact with the inner circumferential surface of the rotor 300, thereby stably maintaining the associated bevel gear. Where the torus crank mechanism of the present invention is applied to an engine, respective guide portions 412 of the bevel gears 410 to 440 also serve to withstand the pressure applied in the central axial direction of the housing assembly 100 when gas pressure is radially inwardly applied to the rotor 300 during a combustion procedure carried out in the chambers 145 to 148. Accordingly, it is possible to prevent the rotor 300 from being deformed or damaged by inertial forces. The balance weight portions 413 of the bevel gears 410 to 440 are adapted to eliminate imbalance problems caused by the eccentric sliders 411, 421, 431, and 441 during rotation of the bevel gears 410 to 440. Preferably, each balance weight portion 413 is formed at a portion of the inner surface of the associated bevel gear opposite to the region where the associated eccentric slider 411 is formed. The hollow portions 414 of each bevel gear are adapted to reduce the weight of the bevel gear while performing the same function as the balance weight portions. The hollow portions 414 may extend through the associated bevel gear so that they are positioned opposite to the associated balance weight portion 413.

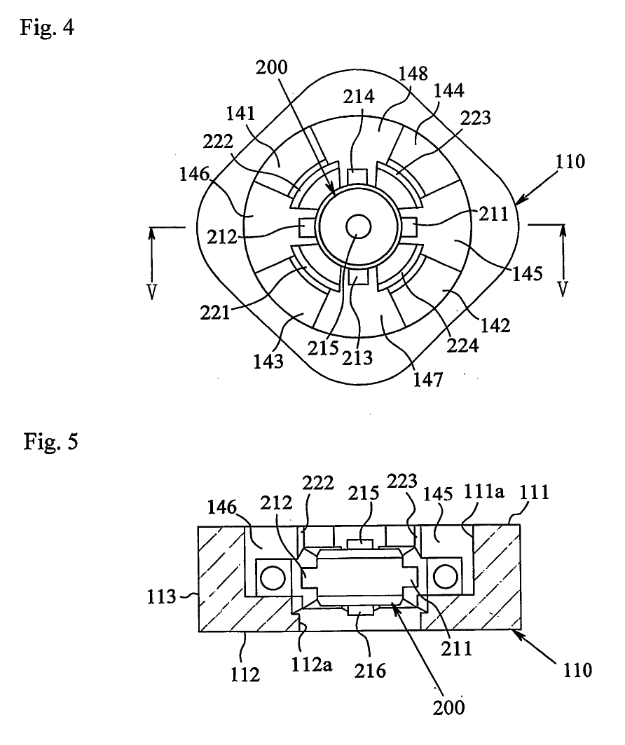

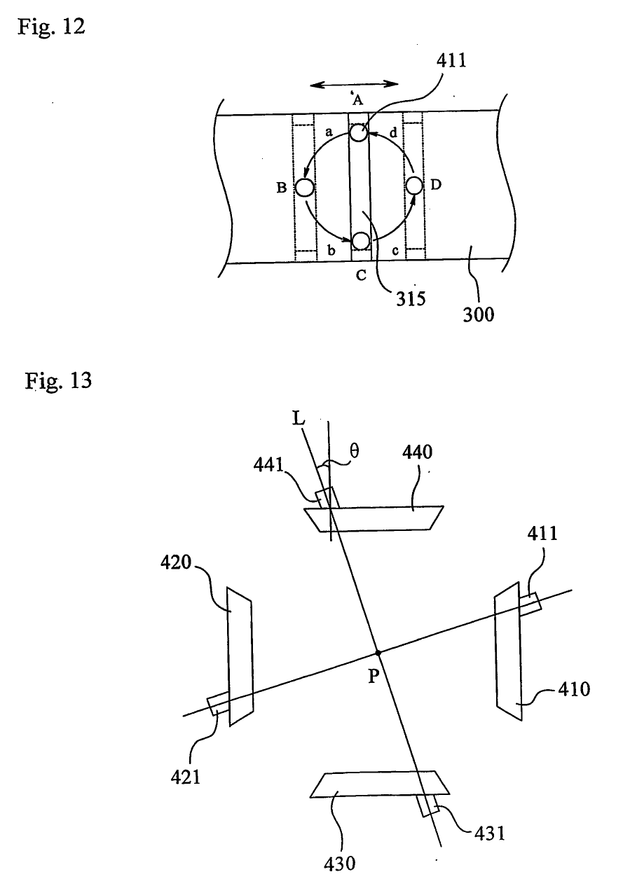

As shown in FIG. 11, the bevel gears 410 to 440 having the above described configuration are rotatably supported by the horizontal shafts 211 to 214 (FIGS. 3 and 4) of the core 200 under the condition in which the eccentric sliders 411, 421, 431, and 441 of the bevel gears 410 to 440 are received in the guide slots 315 to 318 of the rotor 300, respectively. The guide portions 412 of the bevel gears 410 to 440 have an arc shape having a radius of curvature, r₁, identical to the radius of curvature, r, of the inner surface of the rotor body 310. Accordingly, each guide portion 412 comes into contact with the inner circumferential surface of the rotor 300. When the rotor 300 rotates in a reciprocating fashion under this condition, the eccentric slider 411 of each bevel gear, for example, the bevel gear 410, revolves along an arc path in the guide slot 315 of the rotor 300, as shown in FIG. 12. In accordance with the operations of the guide slot 315 and eccentric slider 411, the bevel gear 410 rotates in one direction. The remaining eccentric sliders 421, 431, and 441 move in the same fashion as the eccentric slider 411. Accordingly, no further description will be given in conjunction with the remaining eccentric sliders.

The above described operations of the guide slot 315 and eccentric slider 411 will be described in more detail. As shown in FIG. 12, the eccentric slider 411 positioned at a first position A in the guide slot 315 is moved in a direction indicated by a first arrow a when the rotor 300 moves in the left direction of FIG. 12, so that its position is shifted to a second position B in the guide slot 315. When the rotor 300 changes its movement direction, and moves in the right direction, the eccentric slider 411 is sequentially moved in directions respectively indicated by arrows b and c, so that its position is shifted to a fourth position D via a third position C. Subsequently, the eccentric slider 411 is moved in a direction indicated by a fourth arrow d as the rotor 300 moves again in the left direction, so that it reaches its initial position. (counterclockwise direction) In accordance with such a revolution of the eccentric slider 411 in the guide slot 315, the bevel gear 410 is rotated about the horizontal shaft 211 of the core 200.

However it should also be noted that the bevel gear 410 could be ratated in clockwise direction by adjusting the initial eagaging phase between the eccentric slide and guide slot.

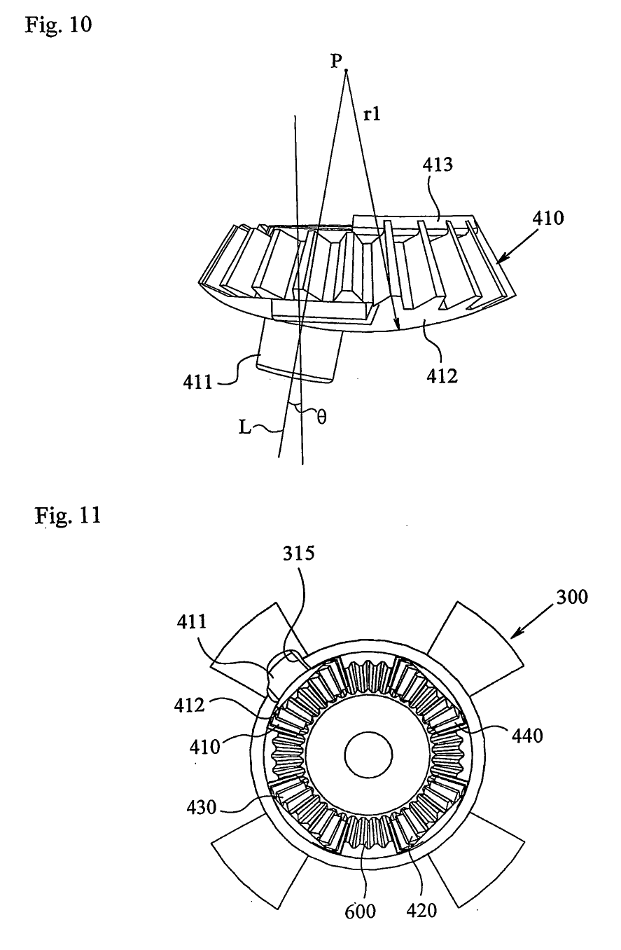

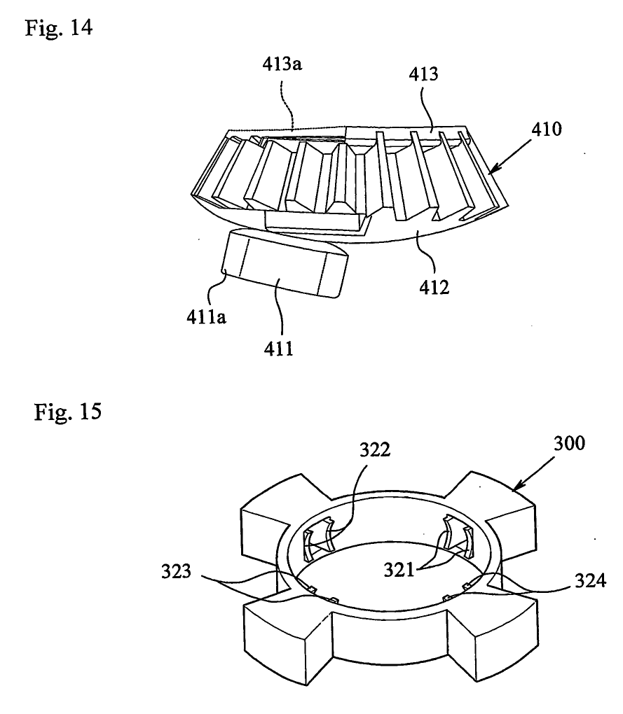

As shown in FIGS. 10 and 13, the eccentric slider 411 of the bevel gear 410 is inclined by a desired angle θ so that the line L extending through the central axis of the eccentric slider 411 passes through the central axis P of the housing assembly 100. In accordance with such an arrangement, the eccentric slider 411 is directed to the central axis of the housing assembly 100 at any position in the guide slot 315. Accordingly, the bevel gear 410 can meet a desired kinematic condition without using any mechanical coupling element such as a hinge or ball joint. As a result, it is possible to achieve a mechanical simplification and operational smoothness of the torus crank mechanism.

FIG. 14 illustrates another bevel gear structure used in the present invention. In this bevel gear structure, a guide roller 411a is fitted around the eccentric slider 411 of each bevel gear, for example, the bevel gear 410, under the condition in which a bearing is interposed between the eccentric slider 411 and the guide roller 411a, in order to allow the eccentric slider 411 to be more smoothly rotated and slid in the guide slot 315. The formation of the weight portion 413 at each bevel gear, for example, the bevel gear 410, causes a step to be formed on the surface of the bevel gear 410 where the balance weight portion 413 is formed. Such a step prevents the bevel gear 410 from coming into uniform contact with the counterpart coupling portion (that is, the facing surface of the core 200). As a result, the rotation of the bevel gear 410 may be hindered. In order to reduce the interference by the step of the bevel gear 410, a leveling member 413a is provided at the surface of the bevel gear 410 where the balance weight portion 413 is formed, as shown in FIG. 14. The leveling member 413a is made of a lightweight material while having the same height as the balance weight portion 413. The leveling member 413a is coupled to the bevel gear 410 using the hollow portions 414.

The rotor 300 included in the torus crank mechanism according to the present invention is preferably made of aluminum alloys, taking into consideration the characteristics thereof. For this reason, the rotor 300 has low hardness and strength, so that it may be abraded at both side walls of each of the guide slots 315 to 318 by the eccentric sliders 411, 421, 431, and 441 of the bevel gears 410 to 440 rotatably sliding in the guide slots 315 to 318. As shown in FIG. 15, the torus crank mechanism of the present invention is configured to prevent the abrasion of the rotor 300 at both side walls of each of the guide slots 315 to 318 by attaching guide members 321 to 324 made of a material having a strength and hardness higher than those of the rotor 300 at respective side walls of the guide slots 315 to 318.

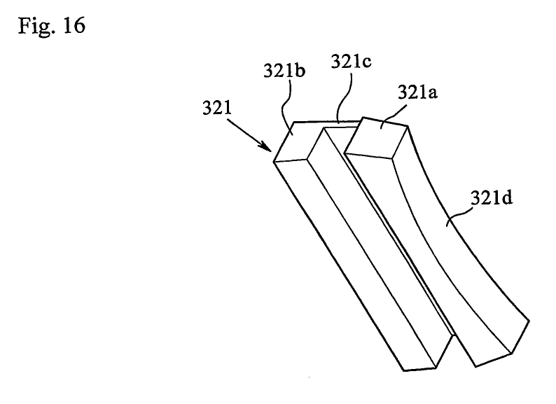

Since the guide members 321 to 324 have the same structure, only one of them, for example, the guide member 321, will be described hereinafter. As shown in FIG. 16, the guide member 321 has a structure in which front and rear portions 321a and 321b are connected by a connecting portion 321c so that they are integral. This guide member 321 may be attached to the wall of the guide slot 315 by mounting the connecting portion 321c to the wall of the guide slot 315 using a fixing element such as a set screw. An arc-shaped support portion 321d is formed at the front portion 321a of the guide member 321. The support portion 321d is curved to have the same radius of curvature as the guide portion 412 of the bevel gear 410. The arc-shaped support portion 321d is in surface contact with the guide portion 412 of the bevel gear 410. As a result, the bevel gear 410 is supported by the shaft 211 of the core 200 under the condition in which its guide portion 412 is in linear contact with the inner circumferential surface of the rotor 300 while being in surface contact with the arc-shaped support portion 321d of the guide member 321. Accordingly, the bevel gear is more stably supported. For example, where the torus crank mechanism of the present invention is applied to an engine, the combustion gas pressure applied to the wall of the rotor 300 can be more effectively supported. The guide member 321 may have other structures. For example, two guide members may be integrally formed for one guide slot.

As shown in FIGS. 1 to 3, the output gears 500 and 600 are mounted to respective vertical shafts 215 and 216 of the core 200 while being engaged with the bevel gears 410 to 440, so that they are rotated as the bevel gears 410 to 440 rotate. Where the four bevel gears 410 to 440 are simultaneously engaged with the output gears 500 and 600, these output gears 500 and 600 are rotated in opposite directions, so that the power shafts 700 respectively connected to the output gears 500 and 600 are rotated in opposite directions. In this case, only one of the output gears 500 and 600, for example, the one output gear 500, may be used to output a desired power, whereas the other output gear 600 is idled. Also, the output gears 500 and 600 are configured to rotate in the same direction, using a separate gear train. Thus, diverse applications may be implemented.

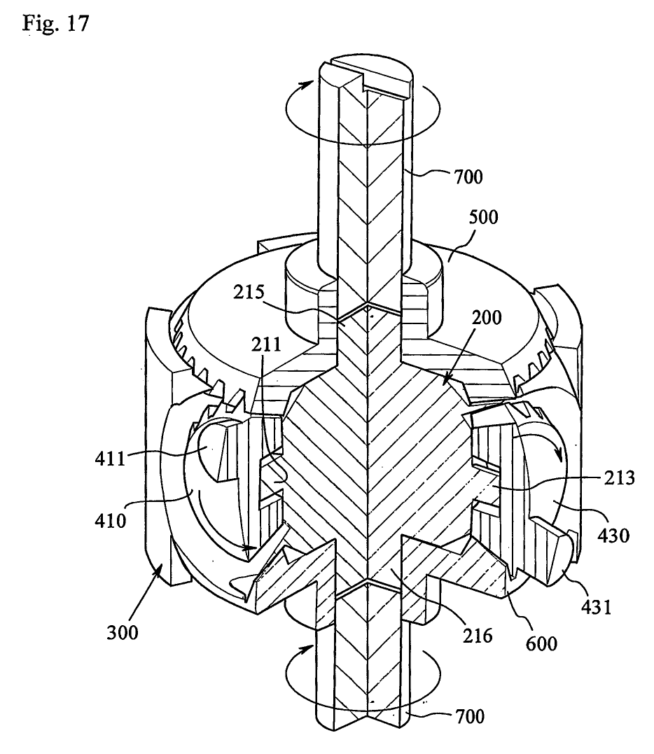

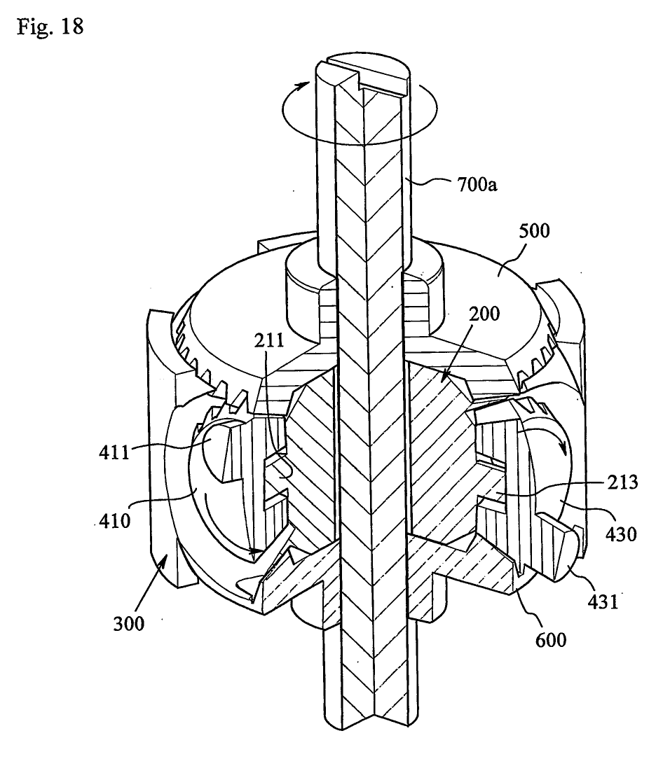

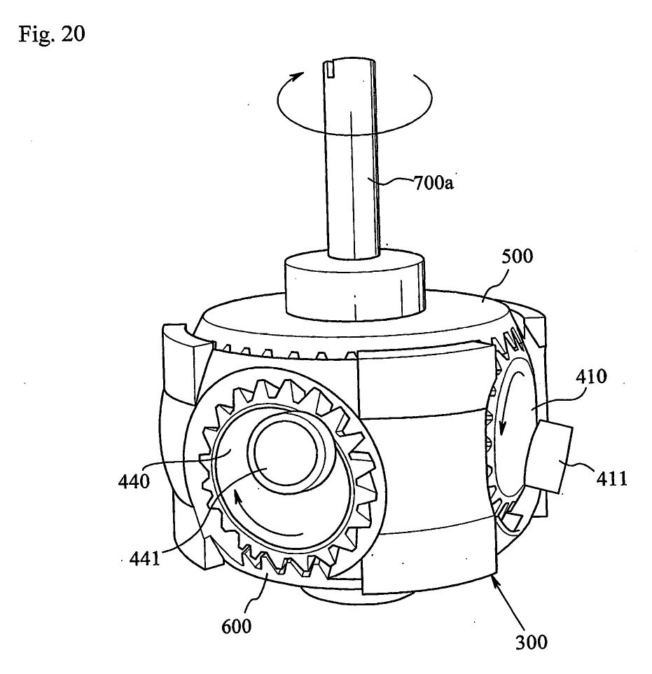

Although the power shafts 700 can be rotated in the same direction by connecting a direction change means such as a gear train to a selected one of the power shafts 700, thereby changing the rotating direction of the selected power shaft 700, the rotation of the power shafts 700 in the same direction can be achieved in a simple and effective fashion without using a separate direction change means. That is, two facing ones of the bevel gears 410 to 440, for example, the bevel gears 410 and 420, are engaged with the upper output gear 500, whereas the remaining two facing bevel gears 430 and 440 respectively arranged adjacent to the bevel gears 410 and 420 are engaged with the lower output gear 600, as shown in FIG. 17. In accordance with this arrangement, the bevel gears 410 and 420 rotate in one direction, for example, a counterclockwise direction, whereas the bevel gears 430 and 440 rotate in the other direction, that is, a clockwise direction. Accordingly, the upper and lower output gears 500 and 600 rotate in the same direction, that is, the clockwise direction, when viewed from above, so that the power shafts 700 are rotated in the same direction. Although the engagement arrangement of the bevel gears with the output gears 500 and 600 to rotate the power shafts 700 in the same direction has been described in conjunction with the four bevel gears 410 to 440, this engagement arrangement may be applied to mechanisms using bevel gears proportional in number to a multiple of 4, without being limited to the case using four bevel gears. For instance, in the case using 8 bevel gears, the upper and lower output gears 500 and 600 can rotate in the same direction by engaging bevel gear pairs each having two facing bevel gears, with the upper and lower output gears 500 and 600 in an alternating fashion, so that the power shafts 700 can be rotated in the same direction.

Where the output gears 500 and 600 are configured to rotate in the same direction, a single power shaft 700a may be used, in place of the two power shafts 700, by forming coaxial hollow portions at the output gears 500 and 600 and the core 200, respectively, as shown in FIG. 18. That is, it is possible to bi-directionally output or input power using only one power shaft 700a by extending the power shaft 700a through the hollow portions of the core 200 while allowing the power shaft 700a to be rotatable in the core 200, and coupling respective hollow portions of the output gears 500 and 600 to opposite end portions of the power shaft 700a Accordingly, it is possible to obtain a miniature high-performance torus crank mechanism using the single power shaft 700a because the power shaft 700a is coupled to both the output gears 500 and 600 even through power is outputted or inputted only in one direction using the power shaft 700a, as shown in FIG. 20.

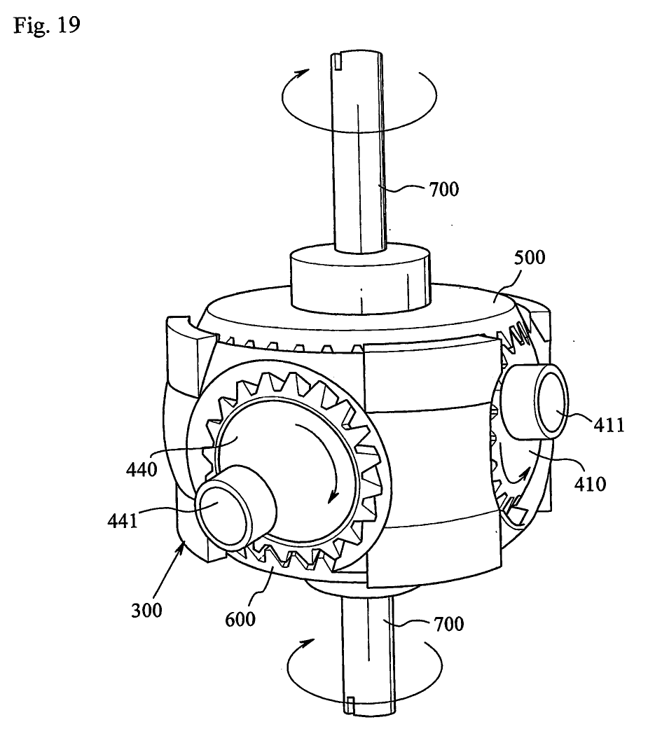

In accordance with the present invention, it is preferable for the eccentric sliders 411, 421, 431, and 441 of the bevel gears 410 to 440 to have eccentric phases having a phase difference of 180° from one another in the rotating direction of the bevel gears, as shown in FIGS. 19 and 20. This condition may be applicable to any mechanisms insofar as an even number of bevel gears are used. Deviations in a center of gravity caused by the eccentric phases of the eccentric sliders 411, 421, 431, and 441 provided at respective bevel gears 410 to 440 are completely offset by the facing bevel gears of the bevel gear pairs. That is, when the eccentric sliders 411, 421, 431, and 441 move in respective guide slots 315 to 318 of the rotor 300, they maintain a desired balance without being inclined. For instance, when the eccentric sliders 411 and 421 rotate, for example, in a counterclockwise direction, in respective guide slots 315 and 316 of the rotor 300 rotating in a reciprocating fashion so that they are moved to their lower positions, as shown in FIG. 19, the remaining eccentric sliders 431 and 441 are rotated in a reverse direction, that is, the clockwise direction, so that they are moved to their upper positions, as shown in FIG. 20. Accordingly, vibrations in upward, downward, left and right directions are offset during the rotation of the eccentric sliders 411, 421, 431, and 441. Thus, generation of vibrations could be minimized. Although the guide slots 315 to 318 of the rotor 300 coupled to respective eccentric sliders 411, 421, 431, and 441 vibrate in upward and downward directions during the rotation of the rotor 300, these vibrations are also offset, so that they are minimized. Accordingly, factors causing a reduction in output power can be minimized.

The reference numeral “150” in FIGS. 1 to 3 denotes an element receiving space provided at the housing body 110 of the housing assembly 100, and adapted to receive an element such as an ignition plug included in an engine to which the torus crank mechanism is applied.

The torus crank mechanism having the above described configuration according to the present invention is widely applicable to diverse industrial engines including engines for vehicles, actuators, compressors for compressing fluid, and pumps for pumping fluid. Hereinafter, such applications will be described.

First, the case in which the torus crank mechanism of the present invention is applied to an engine/actuator serving as a power generating unit.

In this case, respective chambers 145 to 148 of the housing assembly 100 correspond to cylinder bores included in the engine. Respective rotating vanes 311 to 314 of the rotor 300 arranged in the chambers 145 to 148 correspond to pistons included in the engine. Accordingly, where an intake/discharge mechanism and an ignition mechanism (not shown) are provided at opposite sides of the fixed blocks 141 to 144 defining respective chambers 145 to 148, a continuous combustion cycle is carried out within the chambers 145 to 148, thereby causing the rotor 300 to be rotated in a reciprocating fashion in the housing assembly 100 in accordance with the pressure of gas generated in the combustion cycle. This operation is simultaneously carried out in the four chambers 145 to 148. Also, the above operation is carried out at both sides of each rotating vane corresponding to each chamber. Therefore, the torus crank mechanism provided with the four chambers 145 to 148 corresponds to a 8-cylinder type internal combustion engine because the rotating vane in each chamber performs a double action. Thus, it is possible to greatly reduce the size and weight of the engine as compared to a general internal combustion engine, while maintaining the same horse power output.

Since the eccentric sliders 411, 421, 431, and 441 of the bevel gears 410 to 440 mounted to respective horizontal shafts 211 to 214 of the core 200 are received in respective guide slots 315 to 318 of the rotor 300 rotating in a reciprocating fashion in the housing assembly 100, they revolve while rotating and sliding in the guide slots 315 to 318. Accordingly, the bevel gears 410 to 440 are rotated in one direction. The rotating forces from the bevel gears 410 to 440 are transmitted to the output gears 500 and 600 rotatably mounted to respective vertical shafts 215 and 216 of the core 200 and engaged with the bevel gears 410 to 440.

Where each of the upper and lower output gears 500 and 600 is engaged with all bevel gears 410 to 440 during the power transmission procedure, the two power shafts 700 are rotated in opposite directions, respectively. However, where the upper output gear 500 is engaged with the bevel gears 410 and 420, whereas the lower output gear 600 is engaged with the bevel gears 430 and 440, the rotation direction of the bevel gears 410 and 420 is opposite to that of the bevel gears 430 and 440, so that the output gears 500 and 600 are rotated in the same direction. In the latter case, therefore, the power shafts 700 respectively connected to the output gears 500 and 600 can be rotated in the same direction as the rotating direction of the output gears 500 and 600. Also, even when the single power shaft 700a is connected to both the output gears 500 and 600, it can be rotated in the same direction as the rotating direction of the output gears 500 and 600. That is, rotating force of a constant rotating direction can be inputted and outputted without using any separate direction change means.

Now, the case in which the torus crank mechanism of the present invention is applied to a unit receiving a power via a drive means to perform a desired function, for example, a compressor or pump, will be described.

In this case, the output gear 500 and/or output gear 600 is an input part, whereas the rotor 300 is an output part.

Where each of the output gears 500 and 600 is engaged with all bevel gears 410 to 440, only the power shaft 700 of a selected one of the output gears 500 and 600 is rotated using a drive means such as a motor. When the output gear associated with the rotating power shaft 700 is rotated, the rotor 300 is rotated via the bevel gears 410 to 440. On the other hand, where both the output gears 500 and 600 are to be rotated, the power shaft associated with the remaining output gear is rotated in an opposite direction via a direction change means. Thus, the output gears 500 and 600 rotate in opposite directions, respectively, thereby causing the bevel gears 410 to 440 to be rotated in one direction. In accordance with this rotation of the bevel gears 410 to 440, the eccentric sliders 411, 421, 431, and 441 arranged in respective guide slots 315 to 318 of the rotor 300 are moved, thereby causing the rotor 300 to rotate in a reciprocating fashion.

Where the bevel gears 410 and 420 are engaged with the upper output gear 500, whereas the bevel gears 430 and 440 are engaged with the lower output gear 600, only a selected one of the power shafts 700 respectively connected to the output gears 500 and 600 can be rotated using a drive means. Alternatively, both the power shafts 700 can be rotated in the same direction without using any direction change means. Where the single power shaft 700a is applied, it can be rotated without any direction change means. For example, where a selected one of the power shafts 700 rotates, the rotor 300 can be rotated by the two bevel gears engaged with the output gear associated with the selected power shaft 700. On the other hand, where both the power shafts 700 rotate, or the power shaft 700a rotates, the bevel gears 410 and 420 engaged with the output gear 500 and the bevel gears 430 and 440 engaged with the output gear 600 are rotated in one direction, thereby causing the rotor 300 to rotate in a reciprocating fashion.

Where fluid intake/discharge mechanisms (not shown) are provided at each of the fixed blocks 141 to 144 defining the chambers 145 to 148 in the case in which the above described torus crank mechanism is applied to a compressor or pump, one portion of the chamber associated with each rotating vane sucks fluid when the rotor 300 rotates, for example, in the clockwise direction, whereas the other chamber portion compresses fluid, and then discharges the fluid. When the rotor 300 rotates in the counterclockwise direction, operations reverse to the above operations are carried out. As the double action of each rotating vane is repeatedly performed, each chamber, which is divided into two portions by the associated rotating vane, serves as two cylinders for sucking fluid and compressing or pumping the sucked fluid, respectively. Accordingly, it is possible to provide a compressor or pump capable of achieving a high performance while having a small size.

Although the 8-cylinder type torus crank mechanism has been described, in which its housing assembly 100 includes four chambers 145 to 148, its rotor 300 includes four rotating vanes 311 to 314, and four bevel gears 410 to 440 are used, this configuration is intended only for illustrative purposes. In accordance with the present invention, only one chamber may be formed. The torus crank mechanism having only one chamber in accordance with the present invention may be advantageously applied to a miniature compressor such as a compressor for aquariums or artificial hearts. In particular, it is preferable to provide chambers arranged in pairs such that the chambers of each chamber pair face each other, in order to generate a couple of forces. In this case, it is possible to achieve the object of the present invention to minimize generation of vibrations while outputting or inputting rotating forces of the same rotating direction at opposite sides, respectively. When the number of chambers defined in the housing assembly is increased while being an even number such as 2, 4, 6, or 8, it is possible to double the power of the resultant engine and actuator or the capacity of the resultant compressor and pump. In such a case, however, there is little variation in the size of the housing assembly 100 or rotor 300. In this regard, where the torus crank mechanism of the present invention is applied to an engine for ships, it is possible to considerably reduce the size and weight of the resultant engine as compared to general engines, while maintaining the same horse power output.

Although not illustrated and described, two bevel gears may be used where rotating forces of the same rotating direction are outputted and inputted at opposite sides, respectively. That is, it is possible to provide a torus crank mechanism in which one bevel gear is engaged with the upper output gear 500, and another bevel gear is engaged with the lower output gear 600. This torus crank mechanism is also within the scope of the present invention.

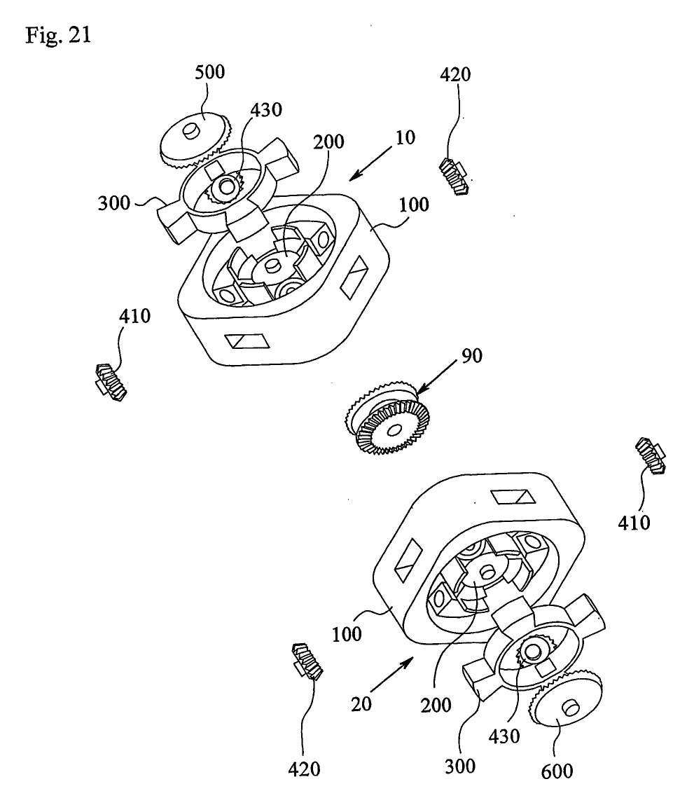

Meanwhile, a plurality of torus crank mechanisms each having the above described configuration may be coaxially connected in accordance with the present invention, thereby forming a multiple torus crank mechanism. Referring to FIG. 21, a double torus crank mechanism is illustrated which is formed by a pair of coaxially connected torus crank mechanisms. Now, another advantage of the torus crank mechanism, that is, an easy applicability, will be described with reference to FIGS. 21 to 24.

As shown in FIG. 21, the multiple torus crank mechanism of the present invention is formed by coaxially connecting at least two torus crank mechanisms (in the illustrated case, two torus crank mechanisms 10 and 20). The basic configuration and function of each torus crank mechanism 10 or 20 are identical to those of the above described torus crank mechanism. Accordingly, elements of each torus crank mechanism 10 or 20 respectively corresponding to those in the above described torus crank mechanism are denoted by the same reference numerals, and no description thereof will be given.

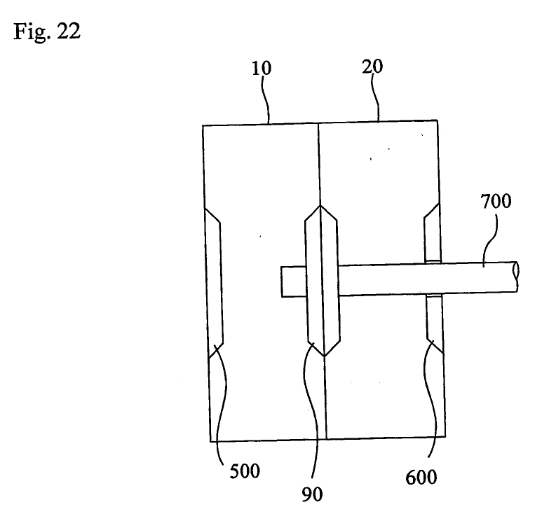

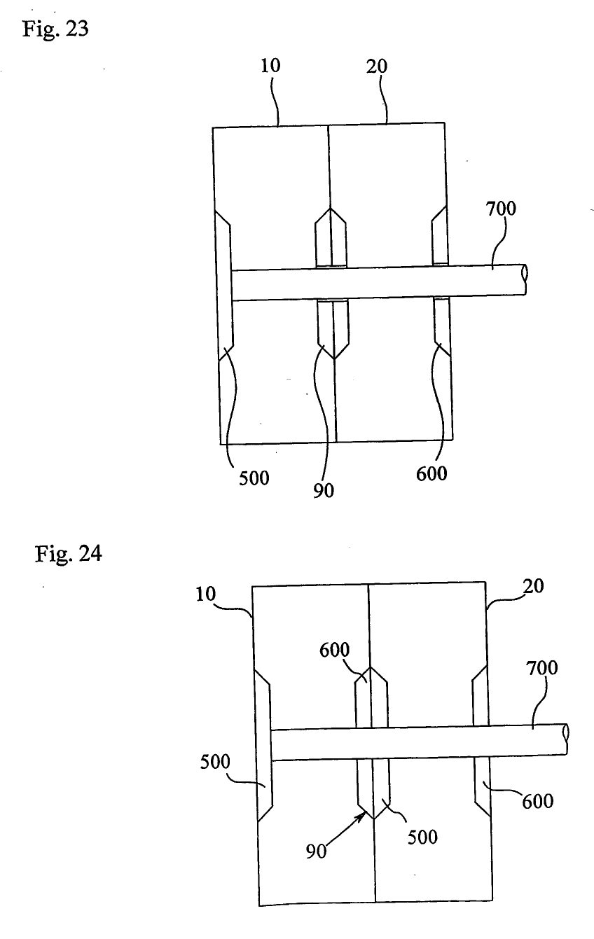

In the case of the double torus crank mechanism shown in FIG. 21, where each of the output gears 500 and 600 is engaged with all bevel gears 410 to 440, one power shaft 700 is connected to two output gears 500 and 600 respectively included in first and second torus crank mechanisms 10 and 20 and arranged adjacent to each other at the central portion of the double torus crank mechanism, as shown in FIG. 22. In this case, the remaining output gears 500 and 600 may be configured to be idled with respect to the power shaft 700. Preferably, the output gears 500 and 600 connected to the power shaft 700 are integrally formed in the form of an output gear 90. As shown in FIG. 23, another arrangement may also be implemented in which the power shaft 700 is connected to a selected one of output gears, whereas the remaining output gears are configured to be idled with respect to the power shaft 700. Such an arrangement may be easily appreciated by skilled persons in the technical field.

A double torus crank mechanism corresponding to a 16-cylinder type internal combustion engine may be implemented by coaxially connecting two torus crank mechanisms each corresponding to an 8-cylinder type internal combustion engine. In accordance with the same principle, it is possible to easily implement a multiple torus crank mechanism applicable to engines of a higher horse power by coaxially connecting three or four torus crank mechanisms. Where only one power shaft 700 is used in such a multiple torus crank mechanism, it is preferable for the output gears rotating in the same direction as the power shaft 700 to be connected to the power shaft 700, and for the remaining output gears to be idled with respect to the power shaft 700. Although not shown, where a multiple torus crank mechanism is formed by coaxially connecting four torus crank mechanisms, double torus crank mechanisms each having the above described configuration are arranged at opposite sides of a mighty gear, and respective power shafts of the double torus crank mechanisms are connected to the mighty gear. In this case, a high horse power engine, actuator, compressor, or pump may be implemented.

Meanwhile, where the output gears 500 and 600 are engaged with pairs of the bevel gears 410 to 440, respectively, the lower output gear 600 of the first torus crank mechanism 10 and the upper output gear 500 of the second torus crank mechanism 20 are integrally formed in the form of an output gear denoted by the reference numeral 90. Also, the housing bodies 110 of the first and second torus crank mechanisms 10 and 20 are coupled together in a sealed state. Thus, a double torus crank mechanism including two torus crank mechanisms is formed. Although not shown, where respective power shafts 700 are connected to the upper output gear 500 of the first torus crank mechanism 10 and the lower output gear 600 of the second torus crank mechanism 20, a 16-cylinder type engine, actuator, compressor, or pump may be implemented. In this case, rotating forces of the same rotating direction can be outputted and inputted through the power shafts 700. In place of the power shafts 700, a single power shaft 700a may be used which extends from the upper output gear 500 of the first torus crank mechanism 10 to the lower output gear 600 of the second torus crank mechanism 20 while being coupled to those output gears 500 and 600, as shown in FIG. 24. In this case, it is possible to transmit, to the power shaft 700a, not only the rotating forces of the output gears 500 and 600, but also the rotating force of the output gear 90 rotating in the same direction as the output gears 500 and 600. Also, the rotating force from the power shaft 700a is transmitted to not only the output gears 500 and 600, but also to the output gear 90. Accordingly, a high horse power unit can be effectively configured. In accordance with the same principle, a plurality of torus crank mechanisms can be coaxially connected without using any separate direction change means. Accordingly, it is possible to easily implement a high horse power multiple torus crank mechanism. In this regard, a high applicability is obtained. Since no direction change means is added, it is possible to provide a multiple torus crank mechanism having a considerably reduced size. An improvement in power transmission efficiency is also obtained because all output gears can transmit rotating forces. In any cases in which a multiple torus crank mechanism is implemented, it is preferable to integrally form the output gears 500 and 600 arranged adjacent to each other in the housing assembly 100, in the form of one output gear 90.

In the above described multiple torus crank mechanisms, it is preferable that the horizontal shafts of the cores 200 are arranged such that those of the adjacent cores have a phase difference of 90° with respect to a center line connecting all centers of the adjacent ones of the cores, in order to minimize generation of vibrations.

The torus crank mechanism of the present invention can be effectively applied to power transmission systems of various industrial machines, for example, machine tools, in addition to engines, actuators, compressors, and pumps. Such applications should also be included in the scope of the present invention.

### INDUSTRIAL APPLICABILITY

In accordance with the torus crank mechanism having the above described configuration according to the present invention, it is not necessary to use mechanical elements occupying a large operating space, for example, crank shafts, in constructing various engines, actuators, compressors, and pumps, as compared to general crank mechanisms. Since central axes of input and output parts are aligned with each other, it is possible to obtain an improved volume efficiency. Accordingly, it is possible to provide an engine, actuator, compressor, or pump greatly reduced in size and weight as compared to conventional ones, while maintaining the same horse power output.

Since the torus crank mechanism of the present invention has a simple and efficient operating configuration, it is possible to manufacture inexpensive engines, actuators, compressors and pumps by mass production.

The torus crank mechanism of the present invention has a superior applicability because it is possible to easily manufacture a high horse power engine or actuator, or a large capacity compressor or pump by coaxially connecting a plurality of torus crank mechanisms.

In accordance with the present invention, it is possible to rotate a pair of power shafts in the same direction without any separate direction change means. Even when a single power shaft is used, it is also possible to output or input power at opposite sides. In this case, an increased applicability is obtained because a multiple torus crank mechanism can be implemented by simply coaxially connecting a plurality of torus crank mechanisms. It is also possible to provide a more effective, miniaturized, and simple arrangement as compared to conventional ones, while maintaining the same horse power output.

Where all output gears are configured to rotate in the same direction, and a power shaft is connected to the output gears, the inner ones of the output gears, as well as the outermost output gears, can transmit a rotating force to the power shaft or receive a rotating force from the power shaft. In this regard, it is possible to more effectively construct a high horse power engine or actuator, or a large capacity compressor or pump.

Since the eccentric sliders provided at the bevel gears are arranged to maintain a desired balance about a center of gravity, it is possible to minimize generation of vibrations. Accordingly, there are various beneficial effects such as minimized power transmission loss, improved durability, and reduced noise.

1. A torus crank mechanism comprising:
a housing assembly providing at least one sealed chamber;
a core centrally arranged in the housing assembly, the core having a vertical shaft protruded from one or each of upper and lower surfaces of the core, and at least one horizontal shaft radially outwardly protruded from an outer circumferential surface of the core;
a rotor arranged in the housing assembly to rotate in a reciprocating fashion around the core, the rotor having at least one rotating blade at an outer circumferential surface thereof, and at least one guide slot at an inner circumferential surface thereof, the rotating blade being arranged in the chamber;
a bevel gear rotatably supported by the horizontal shaft of the core, the bevel gear having an eccentric slider rotatably and slidably received in the guide slot; and
an output gear rotatably supported by the vertical shaft protruded from one or each of the upper and lower core surfaces.

2. The torus crank mechanism according to claim 1, wherein:
the housing assembly comprises a housing body having an outer profile including an upper surface formed with a circular recess, a lower surface formed with a through hole, and side surfaces, first and second covers respectively coupled to the upper and lower surfaces of the housing body, and at least two fixed blocks received in the circular recess to partition the circular recess, thereby defining the at least one chamber; and
the core is integral with the housing body by a plurality of support members extending from the lower surface of the housing body to the upper surface of the housing body.

3. The torus crank mechanism according to claim 1, wherein the rotor is provided with guide members mounted to respective side walls of the guide slots, and made of a material having a strength and hardness higher than those of the rotor.

4. The torus crank mechanism according to claim 1, wherein the eccentric slider of the bevel gear is inclined by a desired angle so that it is directed to a center of the housing assembly at any position of the guide slot.

5. The torus crank mechanism according to claim 1, wherein the bevel gear has a guide portion formed at a surface of the bevel gear where the eccentric slider is formed, the guide portion having the same radius of curvature as the rotor, and a balance weight portion formed at a surface of the bevel gear opposite to the bevel gear surface where the eccentric slider is formed.

6. The torus crank mechanism according to claim 5, wherein the rotor is provided with guide members respectively mounted to respective side walls of the guide slot, and made of a material having a strength and hardness higher than those of the rotor, each of the guide members having an arc-shaped support portion formed at a front surface of the guide member, and curved to have the same radius of curvature as the guide portion of the bevel gear.

7. The torus crank mechanism according to claim 1, wherein a guide roller is mounted to the eccentric slider of the bevel gear.

8. The torus crank mechanism according to claim 1, wherein the rotating blade of the rotor has a hollow structure.

9. A torus crank mechanism comprising:
a housing assembly providing a plurality of sealed chambers arranged in pairs so that the chambers of each chamber pair face each other;
a core centrally arranged in the housing assembly, the core having a vertical shaft protruded from one or each of upper and lower surfaces of the core, and a plurality of horizontal shafts radially outwardly protruded from an outer circumferential surface of the core;
a rotor arranged in the housing assembly to rotate in a reciprocating fashion around the core, the rotor having a plurality of rotating blades at an outer circumferential surface thereof, and a plurality of guide slots at an inner circumferential surface thereof, the guide slots being arranged in pairs so that the guide slots of each guide slot pair face each other, each of the rotating blades being arranged in an associated one of the chambers;
a plurality of bevel gears rotatably supported by the horizontal shafts of the core, respectively, each of the bevel gears having an eccentric slider rotatably and slidably received in an associated one of the guide slots; and
an output gear rotatably supported by the vertical shaft protruded from one or each of the upper and lower core surfaces.

10. The torus crank mechanism according to claim 9, wherein:
the housing assembly comprises a housing body having an outer profile including an upper surface formed with a circular recess, a lower surface formed with a through hole, and side surfaces, first and second covers respectively coupled to the upper and lower surfaces of the housing body, and at least two fixed blocks received in the circular recess to partition the circular recess, thereby defining the chambers; and
the core is integral with the housing body by a plurality of support members extending from the lower surface of the housing body to the upper surface of the housing body.

11. The torus crank mechanism according to claim 9, wherein the rotor is provided with guide members mounted to respective side walls of the guide slots, and made of a material having a strength and hardness higher than those of the rotor.

12. The torus crank mechanism according to claim 9, wherein the eccentric slider of each of the bevel gears is inclined by a desired angle so that it is directed to a center of the housing assembly at any position of an associated one of the guide slots.

13. The torus crank mechanism according to claim 9, wherein each of the bevel gears has a guide portion formed at a surface of the bevel gear where the associated eccentric slider is formed, the guide portion having the same radius of curvature as the rotor, and a balance weight portion formed at a surface of the bevel gear opposite to the bevel gear surface where the associated eccentric slider is formed.

14. The torus crank mechanism according to claim 13, wherein the rotor is provided with guide members respectively mounted to respective side walls of each of the guide slots, and made of a material having a strength and hardness higher than those of the rotor, each of the guide members having an arc-shaped support portion formed at a front surface of the guide member, and curved to have the same radius of curvature as the guide portions of the bevel gears.

15. The torus crank mechanism according to claim 9, wherein a guide roller is mounted to the eccentric slider of each of the bevel gears.

16. The torus crank mechanism according to claim 9, wherein each rotating blade of the rotor has a hollow structure.

17. The torus crank mechanism according to claim 9, wherein the number of the bevel gears is an even number, and the eccentric sliders of the bevel gears have eccentric phases having a phase difference of 180° from one another in the rotating direction of the bevel gears.

18. The torus crank mechanism according to claim 17, wherein the output gear is rotatably supported by the vertical shaft protruded from each of the upper and lower core surfaces, and the bevel gears are engaged, in an alternating fashion, with the output gear arranged at the upper core surface and the output gear arranged at the lower core surface, so that the bevel gears engaged with the upper output gear and the bevel gears engaged with the lower output gear rotate in opposite directions, respectively, thereby causing the upper and lower output gears to rotate in the same direction.

19. The torus crank mechanism according to claim 18, wherein power shafts are connected to the upper and lower output gears, respectively.

20. The torus crank mechanism according to claim 18, wherein the upper and lower output gears and the core have coaxial central through holes, respectively, and a power shaft extends through the central through hole of the core so that opposite ends thereof is coupled with the central through holes of the upper and lower output gears, respectively, whereby a power is outputted or inputted using the power shaft at opposite sides of the power shaft.

21. A multiple torus crank mechanism comprising:
at least two torus crank mechanisms each comprising a housing assembly providing a plurality of sealed chambers arranged in pairs so that the chambers of each chamber pair face each other, a core centrally arranged in the housing assembly, the core having a vertical shaft protruded from one or each of upper and lower surfaces of the core, and a plurality of horizontal shafts radially outwardly protruded from an outer circumferential surface of the core, a rotor arranged in the housing assembly to rotate in a reciprocating fashion around the core, the rotor having a plurality of rotating blades at an outer circumferential surface thereof, and a plurality of guide slots at an inner circumferential surface thereof, the guide slots being arranged in pairs so that the guide slots of each guide slot pair face each other, each of the rotating blades being arranged in an associated one of the chambers, a plurality of bevel gears rotatably supported by the horizontal shafts of the core, respectively, each of the bevel gears having an eccentric slider rotatably and slidably received in an associated one of the guide slots; and an output gear rotatably supported by the vertical shaft protruded from one or each of the upper and lower core surfaces.

22. The multiple torus crank mechanism according to claim 21, wherein the number of the bevel gears in each of the torus crank mechanisms is an even number, and the eccentric sliders of the bevel gears have eccentric phases having a phase difference of 180° from one another in the rotating direction of the bevel gears.

23. The multiple torus crank mechanism according to claim 22, wherein the horizontal shafts of the cores of the torus crank mechanisms are arranged so that those of the adjacent ones of the cores have a phase difference of 90° with respect to a center line connecting all centers of the adjacent cores.

24. The multiple torus crank mechanism according to claim 21, wherein the output gear is rotatably supported by the vertical shaft protruded from each of the upper and lower core surfaces in each of the torus crank mechanism, and the bevel gears are engaged, in an alternating fashion, with the output gear arranged at the upper core surface and the output gear arranged at the lower core surface in each of the torus crank mechanism, so that the bevel gears engaged with the upper output gear and the bevel gears engaged with the lower output gear rotate in opposite directions, respectively, thereby causing the upper and lower output gears to rotate in the same direction.

25. The torus crank mechanism according to claim 24, wherein power shafts are connected to two outermost ones of the output gears in the torus crank mechanisms, respectively.

26. The torus crank mechanism according to claim 24, wherein the upper and lower output gears and the core in each of the torus crank mechanisms have coaxial central through holes, respectively, and a power shaft extends through the central through hole of the core in the torus crank mechanism so that opposite ends thereof is coupled with the central through holes of the upper and lower output gears, respectively, whereby a power is outputted or inputted using the power shaft at opposite sides of the power shaft.

27. The torus crank mechanism according to claim 21, wherein:
the housing assembly in each of the torus crank mechanism comprises a housing body having an outer profile including an upper surface formed with a circular recess, a lower surface formed with a through hole, and side surfaces, first and second covers respectively coupled to the upper and lower surfaces of the housing body, and a plurality of fixed blocks received in the circular recess to partition the circular recess, thereby defining the chambers of the torus crank mechanism; and
the core of the torus crank mechanism is integral with the housing body by a plurality of support members extending from the lower surface of the housing body to the upper surface of the housing body.

28. The torus crank mechanism according to claim 21, wherein among the output gears of the torus crank mechanisms, the output gears arranged adjacent to each other are integrally formed to have a single output gear structure.
